(19) United States
(12) Patent Application Publication
(10) Pub. No.: US 2009/0010147 A1
(43) Pub. Date: Jan. 8, 2009

(54) OPTICAL DISK AND MOLDING DIE APPARATUS

(75) Inventors: Motomitsu Hagiwara, Gunma (JP); Takeshi Otsu, Gunma (JP); Akimasa Miyata, Gunma (JP); Kuniyuki Aihara, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/147,360

(22) Filed: Jun. 26, 2008

(30) Foreign Application Priority Data
Jun. 28, 2007 (JP) 2007-171296

(51) Int. Cl. G11B 7/00; B29C 59/02; B05D 3/00

(52) U.S. Cl. 369/277; 425/112; 427/300; G9B/7

(57) ABSTRACT

A stamper is mounted to a surface of at least one of a stationary-side die and a movable-side die. A transfer surface of the stamper is positioned substantially flush with a first surface of an inner peripheral holding member for holding the stamper near an inner periphery thereof which first surface is positioned adjacent to the transfer surface of the stamper. A first distal end of the inner peripheral holding member, which is positioned to face the cavity, and a second distal end of a die member, which is positioned to face the cavity, the die member being disposed adjacent to the inner peripheral holding member, are both projected more into the cavity than the transfer surface of the stamper. A molding burr can be suppressed from projecting upward from the vicinity of an inner peripheral edge of the substrate surface substantially flush with the transfer portion.

### BACKGROUND OF THE INVENTION

1. Field of the Invention

The present invention relates to an optical disk and a molding die apparatus for producing the optical disk.

2. Description of the Related Art

A disk-shaped optical information recording medium (optical disk) on which information is previously recorded, such as a ROM type optical disk (so-called CD-ROM), or a recordable CD (so-called CD-R), has such a structure, for example, that a recording layer and a reflective layer are formed on one surface of a light transmissive substrate in which pre-grooves, etc. are formed. A laser beam usually having a wavelength of about 780 nm is irradiated to the optical disk from the other surface side of the substrate, whereby data is recorded in the recording layer or is reproduced from the recording layer.

Also, there are proposed optical disks typically known as ROM type digital versatile disk (so-called DVD) on which information is previously recorded and as recordable digital versatile disk (so-called DVD-R). Those optical disks have such a structure, for example, that a recording layer and a reflective layer are formed on one surface of a light transmissive substrate similarly to the above-described optical disks, but pre-grooves are formed in the substrate at a pitch equal to or less than half the pitch in CD-R. A laser beam usually having a wavelength of about 630 nm to 680 nm is irradiated to the optical disk from the other surface side of the substrate, whereby data is recorded in the recording layer or is reproduced from the recording layer.

Meanwhile, with rapidly increasing use of terrestrial high resolution digital TVs, a new disk-shaped optical information recording medium has been recently developed which can record data at a higher density by using a blue-violet laser beam having a shorter wavelength, about 400 nm, than that used for DVD-R.

Studies have been made to reduce a spot diameter and to increase a recording density of the optical disk, for example, by a method of increasing the numerical aperture (NA) of an objective lens and/or a method of shortening the wavelength of a laser beam used. Further, as an optical information recording medium (optical disk) adapted for those methods, it is proposed to record or reproduce data by setting a light-transmissive information recording region to a thickness of about 0.1 mm from one principal surface of the optical information recording medium, the NA to about 0.85, and the wavelength of the laser beam to about 400 nm.

More specifically, there are proposed optical disks typically known as ROM type Blue-ray disk (so-called BD) on which information is previously recorded and as recordable Blue-ray disk (so-called BD-R). Those optical disks have such a structure that a light reflective layer, a light recording layer, and a light transmissive layer are formed in this order on a substrate in which a spiral groove is formed. A blue-violet laser beam usually having a wavelength of about 400 nm to 500 nm is irradiated to the optical disk from a surface of the substrate on the side including the light transmissive layer, whereby data is recorded in the recording layer or is reproduced from the recording layer.

Such an optical disk may be fabricated as follows. A disk-shaped substrate having a center hole is formed by injection molding using a resin with good moldability, e.g., polycarbonate. A reflective layer, a recording layer, and a protective layer each made of a metal, e.g., an Al alloy or an Ag alloy, are formed in this order, as required, on one principal surface of the disk-shaped substrate. Further, a cover layer made of, e.g., a transparent resin, is formed at a thickness of 0.1 mm.

Molding die apparatuses used for molding the substrates of the above-described optical disks are described in Japanese Unexamined Patent Application Publication No. 1-248340, No. 2-134217, and No. 9-174618.

One example of the known molding die apparatuses will be described with reference to FIGS. 14-16. FIG. 14 is a sectional view of a known molding die apparatus 110. FIG. 15 is an enlarged view of a region surrounded by a broken line D in FIG. 14. FIG. 16 is a schematic view showing a section taken in the direction of thickness of the substrate molded by the molding die apparatus. The molding die apparatus 110 has a cavity 115C for molding the substrate, which is formed by respective opposed surfaces of a stationary-side die A and a movable-side die B.

The stationary-side die A includes a stationary-side die plate 111A. A stationary-side core 112A is fixed to the stationary-side die plate 111A by, e.g., bolts (not shown). The stationary-side core 112A is provided with a plurality of cooling water channels 112C for holding a die temperature constant to cool and solidify the substrate. A stamper 113 is mounted to a surface of the stationary-side core 112A, which is positioned to face the cavity 115C, by using an inner peripheral holding member 114A and an outer peripheral holding member 114B. Concaves and convexes corresponding to guide grooves for the substrate of the optical disk, pits for pre-formatting signals, etc. are formed in a transfer surface 113F of the stamper 113, which constitutes a surface defining part of the cavity 115C.

A sprue bush 117 is disposed adjacent to the inner peripheral holding member 114A at the inner peripheral side thereof. The sprue bush 117 slides perpendicularly to a surface of the inner peripheral holding member 114A, which is positioned to face the movable-side die B.

A molten resin channel 115 is constituted by a sprue portion 115A, a runner portion 115B, and the cavity 115C for molding the substrate.

The movable-side die B includes a movable-side die plate 111B. A movable-side core 112B is fixed to the movable-side die plate 111B by, e.g., bolts (not shown) such that the movable-side core 112B is engaged at its inner peripheral side with an inner peripheral retainer 116A and at its outer peripheral side with an outer peripheral retainer 116B.

A center hole boring punch 118 for punching a center hole CH in the substrate is disposed at the inner peripheral side of the inner peripheral retainer 116A. Further, at the center of the center hole boring punch 118, a sprue lock pin 119 is disposed to eject the resin, which has been cooled and solidified in the sprue portion 115A and the runner portion 115B, when the substrate is taken out.

The operation of the molding die apparatus 110 will be described below. First, by using a die fastening mechanism (not shown), the stationary-side die A and the movable-side die B are joined with each other to form the cavity 115C by their opposed surfaces, and are fastened together at high pressure. Then, a resin, e.g., an acrylic resin or a polycarbonate resin, which is heated to high temperature and kept in a molten state, is injected from an injection cylinder (not shown).

The injected molten resin passes through the sprue portion 115A and the runner portion 115B, and is filled into the cavity 115C for molding the substrate.

Because the sprue portion 115A and the runner portion 115B are formed at the center of the stationary-side core 112A, the molten resin is radially uniformly filled into the cavity 115C that is part of the molten resin channel 115.

The molten resin filled in the cavity 115C is cooled and solidified through heat exchange with cooling water flowing through the cooling water channels 112C. As a result, a substrate 121 is formed in the cavity 115C.

During the above step, a center hole 121CH of the substrate 121 is formed by the center hole boring punch 118.

Thereafter, the molding die apparatus 110 is separated into the stationary-side die A and the movable-side die B, and the substrate 121 in the form of a disk having the center hole 121CH is taken out, the substrate 121 as shown in FIG. 16.

At that time, the resin cooled and solidified in the sprue portion 115A and the runner portion 115B each constituting the molten resin channel 115 is also taken out in a state adhering to the movable-side die B. That resin is removed to the exterior of the molding die apparatus 110 by ejecting the sprue lock pin 119.

Further, in the molding die apparatus 110, the transfer surface 113F of the stamper 113 is positioned substantially flush with a distal end 114AF of the inner peripheral holding member 114A, which is positioned to face the cavity 115C, such that a transfer portion 121TP of the substrate, to which the transfer surface 113F of the stamper 113 is transferred, is formed substantially in a flat surface.

The molded substrate 121 has, on its one principal surface to which the transfer surface 113F of the stamper 113 has been transferred, the transfer portion 121TP including the guide grooves, the pits for the pre-formatting signals, etc.

Though not specifically shown, as denoted just by reference numerals in FIGS. 17 and 18, a reflective layer 122 made of a metal or an alloy, a recording layer 123 containing a dye, etc., and a protective layer 124 are formed in this order, as required, on the transfer portion 121 TP of the substrate 121.

Further, as shown in FIGS. 17 and 18, a coating solution of a transparent resin material 128 is applied by spin coating in a state where the center hole 121CH of the substrate 121 is covered with a center cap 126, thereby forming a cover layer 125 which covers the protective layer 124 and which is made of a transparent resin film having a thickness of about 0.1 mm. An optical disk 120 is thus obtained in the above-described structure.

A laser beam with a wavelength of, e.g., 405 nm is irradiated to the optical disk 120 from one side of the substrate 121 including the cover layer 125 to record or reproduce data, e.g., user information.

However, the molding die apparatus 110 thus constructed has the problem that, as shown in FIG. 16, a molding burr 121EX projecting from the flat surface of the transfer portion 121TP of the molded substrate 121 in the inner peripheral side of the transfer portion 121TP tends to form due to a gap at a sliding surface CS between the inner peripheral holding member 114A for fixing the inner peripheral side of the stamper 113 and a die member (e.g., the sprue bush 117) positioned adjacent to the inner peripheral holding member 114A at the inner peripheral side thereof.

In the state of the molding burr 121EX being formed to project from the flat surface of the transfer portion 121TP of the molded substrate 121 in the inner peripheral side of the transfer portion 121TP, however, when the cover layer 125 is formed by spin coating with the center cap 126 set in place, as shown in FIG. 17, after successively forming, e.g., the reflective layer 122, the recording layer 123, and the protective layer 124 as required, the center cap 126 cannot be held in close contact with the flat surface of the substrate 121. If the resin material is applied in such a condition, entrainment of bubbles and streak-like coating marks are caused in a coating film of the cover layer 125, as shown in FIG. 18. Thus, a failure of external appearance is apt to occur.

Another problem is that, in the optical disk 120 suffering from the entrainment of bubbles and the streak-like coating marks in the cover layer 125, when the laser beam is irradiated to the substrate from the side including the cover layer 125, a failure in recording and/or reproducing is apt to occur due to a partial change in reflectance of light by the presence of the bubbles, etc.

### SUMMARY OF THE INVENTION

An object of the present invention is to provide a molding die apparatus in which a molding burr projecting from a substrate surface substantially flush with a transfer portion of a substrate is more reliably avoided from forming near an inner peripheral edge of the substrate surface substantially flush with the transfer portion of the substrate to which a transfer surface of a stamper is transferred.

According to the present invention, the above-mentioned object is achieved by positioning the transfer surface of the stamper substantially flush with a surface of part of a cylindrical inner peripheral holding member disposed adjacent to the stamper, and by arranging a distal end of the inner peripheral holding member and a distal end of a die member disposed adjacent to the inner peripheral holding member to be both projected from a surface of the part of the inner peripheral holding member, which is positioned adjacent to the transfer surface of the stamper.

Thus, a molding die apparatus according to the present invention comprises a stationary-side die and a movable-side die, the stationary-side die and the movable-side die forming a cavity by opposed surfaces thereof at least one of the stationary-side die and the movable-side die including a stamper which has a transfer surface formed in one principal surface thereof and which is mounted to one of the opposed surfaces to constitute a surface defining part of the cavity. The molding die apparatus may mold a disk-shaped substrate having a center hole from a molten resin injected into the cavity. The transfer surface of the stamper is positioned substantially flush with a surface of part of a cylindrical inner peripheral holding member for holding the stamper near an inner periphery thereof, which surface is positioned adjacent to the transfer surface of the stamper. Further, a distal end of the inner peripheral holding member, which is positioned to face the cavity, and a distal end of a die member, which is positioned to face the cavity, the die member being disposed adjacent to the inner peripheral holding member at the inner peripheral side thereof, are both projected more into the cavity than the surface of the part of the inner peripheral holding member, which is positioned adjacent to the transfer surface of the stamper.

Therefore, even when a molding burr is formed on the substrate along a sliding surface between the inner peripheral holding member and the die member disposed adjacent to the inner peripheral holding member at the inner peripheral side thereof, the molding burr is suppressed from projecting upward from the vicinity of an inner peripheral edge of the substrate surface which is substantially flush with a transfer portion formed in one principal surface of the substrate.

As a result, the substrate for an optical disk can be stably produced in which the molding burr formed on the substrate along the sliding surface between the inner peripheral holding member and the die member disposed adjacent to the inner peripheral holding member at the inner peripheral side thereof is suppressed from projecting upward from the vicinity of the inner peripheral edge of the substrate surface which is substantially flush with the transfer portion formed in one principal surface of the substrate.

Another object of the present invention is to provide an optical disk which has high quality and is free from an external appearance failure caused by entrainment of bubbles and streak-like coating marks that are generated in a coating film forming a cover layer.

Still another object of the present invention is to provide an optical disk which has high quality and is less apt to cause a failure in recording and/or reproducing due to entrainment of bubbles and streak-like coating marks that are generated in the coating film forming the cover layer.

According to the present invention, those objects are achieved by forming a cover layer made of a transparent resin film on a substrate molded by the above-mentioned molding die apparatus over a transfer portion of the substrate to which a transfer surface of a stamper has been transferred, by spin coating directly or with interposition of one or more other layers under the cover layer.

Thus, an optical disk according to the present invention has a cover layer made of a transparent resin film and coated on a substrate molded by the above-mentioned molding die apparatus, wherein a center cap is set to cover a center hole of the substrate and an area of a surface of the substrate extending from the vicinity of an inner peripheral edge of the substrate positioned substantially flush with a transfer portion of the substrate, to which a transfer surface of a stamper has been transferred. A surface of the transfer portion is covered by spin coating directly or with interposition of one or more other layers under the cover layer.

Therefore, even with the presence of the molding burr when the cover layer is coated and formed on the substrate by spin coating in the state of the center cap being set in place, the center cap covering the center hole of the substrate can be held in close contact with the inner peripheral edge of the substrate surface, which is positioned substantially flush with the transfer portion of the substrate. The cover layer made of the transparent resin film can be hence obtained in which generation of entrainment of bubbles and streak-like coating marks is suppressed.

As a result, a high-quality optical disk free from an outer experience failure can be obtained because it has the cover layer made of the transparent resin film in which generation of entrainment of bubbles and streak-like coating marks is suppressed.

Further, a high-quality optical disk free from a failure in recording and/or reproducing can be obtained because it has the cover layer made of the transparent resin film in which generation of entrainment of bubbles and streak-like coating marks is suppressed.

The above and other objects, structural features, and working advantages of the present invention will be apparent by referring to the following description and the accompanying drawings.

### BRIEF DESCRIPTION OF THE DRAWINGS

FIG. 1 is a sectional view showing an internal structure of a molding die apparatus according to a first embodiment of the present invention;

FIG. 2 is a partial enlarged sectional view of the molding die apparatus according to the first embodiment, the view showing a region surrounded by a broken line C in FIG. 1;

FIG. 3 is a schematic sectional view showing a substrate of an optical disk, which is molded by using the molding die apparatus according to the first embodiment;

FIG. 4 is a schematic sectional view showing a state where a resin material forming a cover layer is coated on the substrate of the optical disk according to the first embodiment;

FIG. 5 is a schematic sectional view showing an internal structure of the optical disk according to the first embodiment of the present invention;

FIG. 6 is a partial enlarged sectional view of a molding die apparatus according to a modification of the first embodiment;

FIG. 7 is a schematic sectional view showing a substrate of an optical disk, which is molded by using the molding die apparatus according to the modification of the first embodiment;

FIG. 8 is a partial enlarged sectional view showing an internal structure of a molding die apparatus according to a second embodiment of the present invention;

FIG. 9 is a schematic sectional view showing a substrate of an optical disk, which is molded by using the molding die apparatus according to the second embodiment;

FIG. 10 is a schematic sectional view showing an internal structure of the optical disk according to the second embodiment of the present invention;

FIG. 11 is a partial enlarged sectional view showing an internal structure of a molding die apparatus according to a third embodiment of the present invention;

FIG. 12 is a schematic sectional view showing a substrate of an optical disk, which is molded by using the molding die apparatus according to the third embodiment;

FIG. 13 is a schematic sectional view showing an internal structure of the optical disk according to the third embodiment of the present invention;

FIG. 14 is a sectional view of a molding die apparatus of the related art;

FIG. 15 is an enlarged view showing the molding die apparatus of the related art;

FIG. 16 is a schematic view showing a substrate molded by using the molding die apparatus of the related art; and

FIG. 17 is a schematic sectional view showing a state where a resin material forming a cover layer is coated on the substrate molded by using the molding die apparatus of the related art; and

FIG. 18 is a schematic sectional view showing an optical disk of the related art.

### DESCRIPTION OF THE PREFERRED EMBODIMENTS

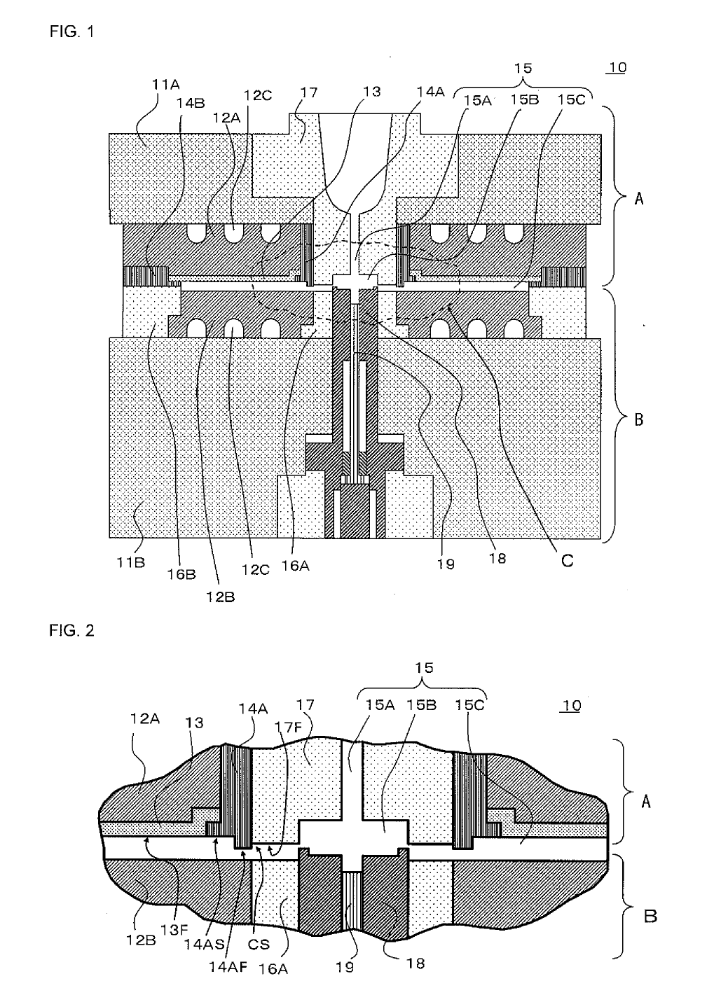

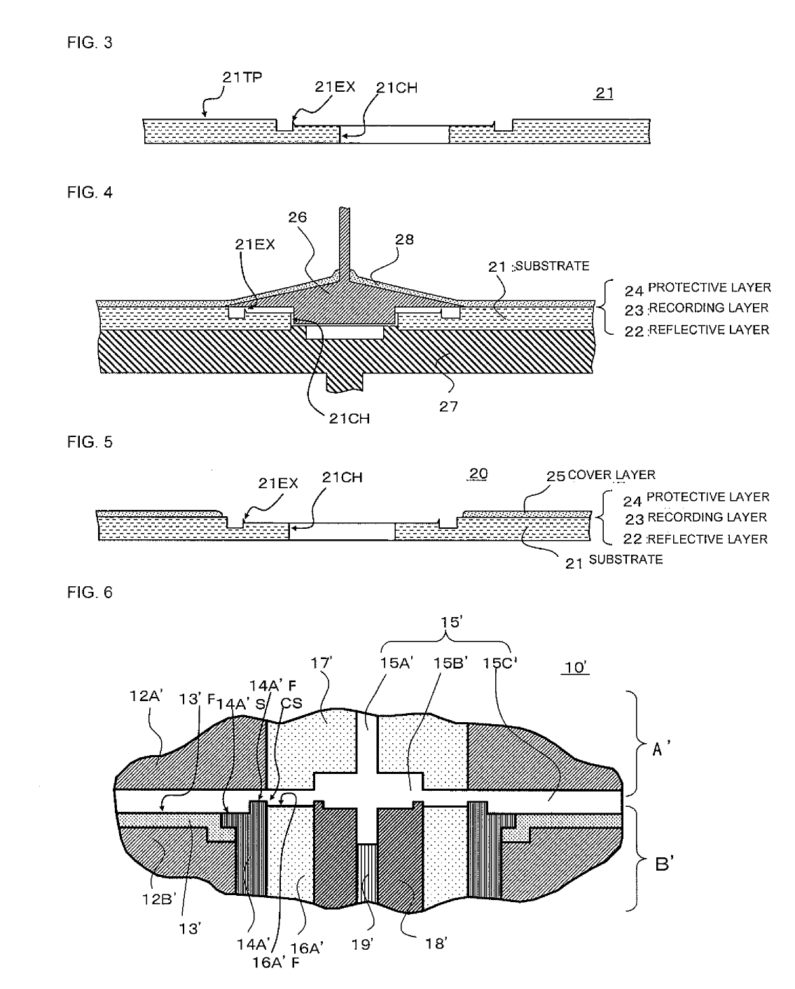

A molding die apparatus according to a first embodiment of the present invention will be described below with reference to FIGS. 1-3. FIG. 1 is a sectional view showing an internal structure of one example of a molding die apparatus 10 according to the first embodiment. FIG. 2 is a partial enlarged sectional view of the molding die apparatus according to the first embodiment, the view showing a region surrounded by a broken line C in FIG. 1. FIG. 3 is a schematic sectional view showing a substrate 21 of an optical disk, which is molded by the molding die apparatus according to the first embodiment.

In the molding die apparatus 10 according to the first embodiment, as shown in FIGS. 1 and 2, a cavity 15C for molding the substrate is formed by opposed surfaces of a stationary-side die A and a movable-side die B.

The upper surface side of the cavity 15C is mainly defined by a transfer surface of a stamper 13 described later. Also, an outer periphery of the cavity 15C is mainly defined by a circular outer peripheral surface of an outer peripheral holding member 14B described later. Further, the bottom surface side of the cavity 15C is mainly defined by an upper surface of a movable-side core 12B described later.

The stationary-side die A includes a stationary-side die plate 11A. A stationary-side core 12A is fixed to the stationary-side die plate 11A by, e.g., bolts (not shown). The stationary-side core 12A is provided with a plurality of cooling water channels 12C for holding a die temperature constant to cool and solidify the substrate. A stamper 13 in the form of a substantially circular plate having an opening at its center is mounted to a surface of the stationary-side core 12A, which is positioned to face the cavity 15C, by using an inner peripheral holding member 14A, which has a hollow cylindrical shape and includes a flange formed on an outer periphery of its head portion, and a ring-shaped outer peripheral holding member 14B. Concaves and convexes corresponding to guide grooves for the substrate of the optical disk, pits for pre-formatting signals, etc. (not shown) are formed in a transfer surface 13F of the stamper 13, which constitutes a surface defining part of the cavity 15C. In addition, a flange having a crank-shaped section is formed at the inner peripheral side of the stamper 13 to be engaged with the flange that is formed in the head portion of the inner peripheral holding member 14A.

A sprue bush 17 is disposed as a die member adjacent to the inner peripheral holding member 14A at the inner peripheral side thereof. The sprue bush 17 slides perpendicularly to a surface of the inner peripheral holding member 14A, which is positioned to face the movable-side die B.

A molten resin channel 15 is constituted by a sprue portion 15A, a runner portion 15B, and the cavity 15C for molding the substrate.

The movable-side die B includes a movable-side die plate 11B. A movable-side core 12B is fixed to the movable-side die plate 11B by, e.g., bolts (not shown) such that the movable-side core 12B is engaged at its inner peripheral side with an inner peripheral retainer 16A and at its outer peripheral side with an outer peripheral retainer 16B.

A center hole boring punch 18 for punching a center hole 21CH in the molded substrate to provide a shape of the optical disk is disposed at the inner peripheral side of the inner peripheral retainer 16A. Further, at the center of the center hole boring punch 18, a sprue lock pin 19 is disposed to eject the resin, which has been cooled and solidified in the sprue portion 15A and the runner portion 15B each constituting the molten resin channel 15, when the substrate is taken out.

The operation of molding the substrate of the optical disk by the molding die apparatus 10 will be described below. First, by using a die fastening mechanism (not shown), the stationary-side die plate 11A and the movable-side die plate 11B are joined with each other to form the cavity 15C and are fastened together at high pressure. Then, a resin, e.g., an acrylic resin or a polycarbonate resin, which is heated to high temperature and kept in a molten state, is injected from an injection cylinder (not shown).

The injected molten resin passes through the sprue portion 15A and the runner portion 15B, and is filled into the cavity 15C for molding the substrate.

Because the sprue portion 15A and the runner portion 15B are formed at the center of the stationary-side core 12A, the molten resin is substantially radially uniformly filled into the cavity 15C.

The molten resin filled in the cavity 15C is cooled and solidified through heat exchange with cooling water flowing through the cooling water channels 112C. As a result, the substrate 21 is formed in the cavity 15C.

During the above step, the center hole 21CH of the substrate 21 is formed by the center hole boring punch 18.

Thereafter, the molding die apparatus 10 is separated into the stationary-side die A and the movable-side die B, and the substrate 21 in the form of a disk having the center hole 21CH is taken out, the substrate 21 as shown in FIG. 3.

At that time, the resin cooled and solidified in the sprue portion 15A and the runner portion 15B each constituting the molten resin channel 115 is also taken out in a state adhering to the movable-side die B. That resin is removed to the exterior of the molding die apparatus 10 by ejecting the sprue lock pin 19.

Further, in the molding die apparatus 10, the transfer surface 13F of the stamper 13 is positioned substantially flush with a surface 14AS of part of the inner peripheral holding member 14A for holding the stamper 13 near its inner peripheral portion, the partial surface 14AS being adjacent to the transfer surface 13F of the stamper 13.

Still further, a distal end 14AF of the inner peripheral holding member 14A, which is positioned to face the cavity 15C, and a distal end 17F of the sprue bush 17, which is also positioned to face the cavity 15C, the sprue bush 17 being disposed as the die member adjacent to the inner peripheral holding member 14A at the inner peripheral side thereof, are both projected toward the more inner side of the cavity 15C than the partial surface 14AS of the inner peripheral holding member 14A, which is positioned adjacent to the transfer surface 13F of the stamper 13.

As shown in FIG. 3, therefore, a surface of the substrate 21 is recessed relative to a transfer portion 21TP of the substrate 21, to which the transfer surface 13F of the stamper 13 has been transferred, in an area subjected to transfer of both the distal end 14AF of the inner peripheral holding member 14A, which is positioned to face the cavity 15C, and the distal end 17F of the sprue bush 17, which is also positioned to face the cavity 15C, the sprue bush 17 being disposed as the die member adjacent to the inner peripheral holding member 14A at the inner peripheral side thereof. Hence, a molding burr 21EX formed on the substrate 21 along a sliding surface between the inner peripheral holding member 14A and the sprue bush 17 disposed as the die member adjacent to the inner peripheral holding member 14A at the inner peripheral side thereof is located in the recessed portion in the surface of the substrate 21. As a result, the molding burr 21EX is suppressed from projecting upward from the vicinity of an inner peripheral edge of the substrate surface which is substantially flush with the transfer portion 21TP in one principal surface of the substrate 21.

The molded substrate 21 has, on its one principal surface to which the transfer surface 13F of the stamper 13 has been transferred, the transfer portion 21TP including the guide grooves, the pits for the pre-formatting signals, etc. (not shown).

Moreover, in the molding die apparatus 10 of this embodiment, the distal end 14AF of the inner peripheral holding member 14A, which is positioned to face the cavity 15C, is projected toward the more inner side of the cavity 15C than the distal end 17F of the sprue bush 17, which is also positioned to face the cavity 15C, the sprue bush 17 being disposed as the die member adjacent to the inner peripheral holding member 14A at the inner peripheral side thereof. This arrangement provides such a merit that resistance against the molten resin flowing in the cavity 15C is relatively small.

The optical disk according to the first embodiment of the present invention will be described in more detail below with reference to FIGS. 4 and 5. FIG. 4 is a partial enlarged sectional view showing one example of a cover layer forming process in an optical disk 20 according to the first embodiment of the present invention. FIG. 5 is a schematic sectional view showing an internal structure of the optical disk 20 according to the first embodiment.

In the optical disk 20 according to the first embodiment of the present invention, wherein the following layers are denoted just by reference numerals in FIG. 5 instead of detailed illustration, a reflective layer 22 made of a metal or an alloy, a recording layer 23 containing a dye, etc., and a protective layer 24 made of, e.g., a transparent inorganic material are formed in this order on the transfer portion 21TP of the substrate 21 which has been molded by using the molding die apparatus 10. Further, a cover layer 25 made of a transparent resin film having a thickness of about 0.1 mm is formed to cover the protective layer 24. The optical disk 20 is thus obtained in the above-described structure.

In one example of a process for forming the cover layer 25, as shown in FIG. 4, the substrate 21 is placed on a turntable 27 such that the center hole 21CH of the substrate 21 is fitted to a central boss of the turntable 27. A coating solution of a transparent resin material 28 is applied by spin coating in a state where the center hole 21CH of the substrate 21 is covered with a center cap 26. On that occasion, although the molding burr 21EX is present in the recessed portion of the substrate 21, the molding burr 21EX is suppressed from projecting upward from the vicinity of the inner peripheral edge of the substrate surface which is substantially flush with the transfer portion 21TP of the substrate 21 on which the reflective layer 22, the recording layer 23 and the protective layer 24 have been formed in this order. Accordingly, the center cap 26 covering the center of the substrate 21 can be held in close contact with the vicinity of the inner peripheral edge of the substrate surface substantially flush with the transfer portion 21TP, which corresponds to an edge of the recessed portion of the substrate 21. As a result, when the cover layer 25 is formed by spin coating, the entrainment of bubbles and the streak-like coating marks can be suppressed which are otherwise generated in the transparent resin film forming the cover layer 25.

Embodiments of various parts of the optical disk 20 will be described below.

An embodiment of the substrate 21 is as follows. The substrate 21 can be made by selecting one or more of various materials which are used as substrate materials for the known optical information recording media. A specific example of the substrate materials is an acrylic resin, including polycarbonate and polymethylmethacrylate. Plural types of materials may be used in the form of laminated layers, as required. Among the above-mentioned materials, a thermoplastic resin is advantageous from the viewpoints of moldability, moisture resistance, dimensional stability, cost efficiency, etc. In particular, polycarbonate is preferred.

When using the above-mentioned resins, the substrate 21 may be formed into a predetermined shape (annular shape in the case of an optical disk) by injection molding, for example. Also, the substrate 21 preferably has a thickness in the range of 0.9 to 1.6 mm.

Concaves and convexes (not shown) corresponding to guide grooves, pits for pre-formatting signals, etc. for the purpose of recording and/or reproducing with irradiation of a laser beam are preferably formed in one principal surface of the substrate 21 where the light reflective layer 22 is formed. The guide grooves are preferably formed, for example, at a depth of 20 nm to 300 nm and a pitch of 500 nm or less in usual cases.

An embodiment of the recessed portion in the one principal surface of the substrate 21 where the molding burr 21EX is formed is as follows. The recessed portion may be formed at the same time as the molding of the substrate 21 in the surface of the substrate 21 on the side including the transfer portion 21TP at a position nearer to an inner periphery than a region in which the concaves and convexes corresponding to the guide grooves, etc. are formed. The recessed portion preferably has a depth of, e.g., about 0.02 mm to about 1.0 mm. Also the recessed portion preferably has a width of, e.g., about 0.02 mm to about 1.0 mm. In addition, the recessed portion is preferably formed in a ring-like shape about a center axis of the substrate 21.

The recessed portion is deeper than the guide grooves and is difficult to form by the stamper 13. For that reason, preferably, concentric projections protruding into the cavity 15C from the surface of a portion of the inner peripheral holding member 14A, which is positioned adjacent to the transfer surface 13F of the stamper 13, are provided on the inner peripheral holding member 14A for fixing the inner peripheral side of the stamper 13 and the die member adjacent to the inner peripheral holding member 14A, respectively, such that the recessed portion is formed at the same time as the molding of the substrate 21.

An embodiment of the reflective layer 22 is as follows. The reflective layer 22 serves to reflect a laser beam for recording and/or reproducing of data. In the present invention, to provide the functions of increasing reflectance for the laser beam and improving characteristics of recording and reproducing, the reflective layer 22 may be disposed, as required, between the substrate 21 and the recording layer 23. The reflective layer 22 may be made of, for example, a metal film such as Au, Al, Ag, Cu or Pd, an alloy film of two or more of those metals, or an alloy film added with a trace amount of one or more of those metals. Further, the reflective layer 22 is preferably formed on the surface of the substrate 21, on which the transfer portion 21TP is formed, by vacuum deposition, ion plating, or sputtering, for example. Among those methods, sputtering is particularly advantageous from the viewpoints of mass production and cost. Note that the reflective layer 22 is disposed as required. The reflective layer 22 can be omitted, for example, in the case of a rewritable optical disk using the so-called phase-change type recording layer made of an inorganic material.

An embodiment of the recording layer 23 is as follows. The recording layer 23 may be formed as a dye type recording layer containing an organic dye as a recording substance, or a phase-change type recording layer containing an inorganic material as a recording substance. In particular, the dye type recording layer may be more advantageous in which data is recorded by forming pits with irradiation of a laser beam. Examples of the organic dye include a phthalocyanine dye, a cyanine dye, and azo-based dyes. By irradiating the laser beam, data information including music, images, computer programs, etc. can be recorded in the recording layer 23 or reproduced from there. The recording layer 23 can be formed through the steps of preparing a coating solution by dissolving the dye in an appropriate solvent together with a binder, etc., applying the coating solution on the transfer portion 21TP of the substrate 21 by, e.g., spin coating or screen printing with interposition of the reflective layer 22 under the recording layer 23 as required, thereby forming a coating film, and drying the coating film. Note that the recording layer 23 is disposed as required. The recording layer 23 can be omitted, for example, in the case of an optical disk of the so-called ROM type containing information recorded in advance.

An embodiment of the protective layer 24 is as follows. The protective layer 24 may be formed by vacuum deposition or sputtering, for example, using a transparent inorganic material such as ZnS, SiO₂, SiN, AlN, ZnS—SiO₂, and SiC.

The protective layer 24 may be formed between the dye type recording layer 23 and the cover layer 25 for the purposes of, e.g., adjusting recording characteristics, increasing adhesion, and protecting the recording layer 23.

Note that the protective layer 24 is disposed as required. The protective layer 24 can be omitted, for example, in the case of the rewritable optical disk using the so-called phase-change type recording layer made of an inorganic material, or the ROM type optical disk.

An embodiment of the cover layer 25 is as follows. The cover layer 25 may be formed through the steps of preparing a coating solution by dissolving a transparent ultraviolet-curing resin material 28 in an appropriate solvent, mounting the center cap 26 in place to cover the center hole 21CH of the substrate 21, applying the coating solution on a region extending to span over the surface of the transfer portion 21TP from the vicinity of the inner peripheral edge of the substrate 21, the inner peripheral edge being positioned substantially flush with the transfer portion 21TP of the substrate 21 to which the transfer surface 13F of the stamper 13 has been transferred, by spin coating or screen printing directly or with interposition of one or more layers (e.g., one or more of the reflective layer 22, the recording layer 23 and the protective layer 24) under the cover layer 25, thereby forming a coating film, and irradiating an ultraviolet ray to the coating film after drying it.

The cover layer 25 is not limited to the transparent resin film of a single layer. For example, the cover layer 25 may have a multilayered structure comprising a first cover layer made of a transparent resin film and one or more of second, third, and subsequent transparent resin films each of which is formed in the same manner as described above.

In view of that the laser beam having a wavelength of about 400 nM to 500 mm is usually irradiated to record data in the recording layer 23 and to reproduce data from the recording layer 23, a total thickness of the protective layer 24 and the cover layer 25 is preferably about 0.1 mm in usual cases.

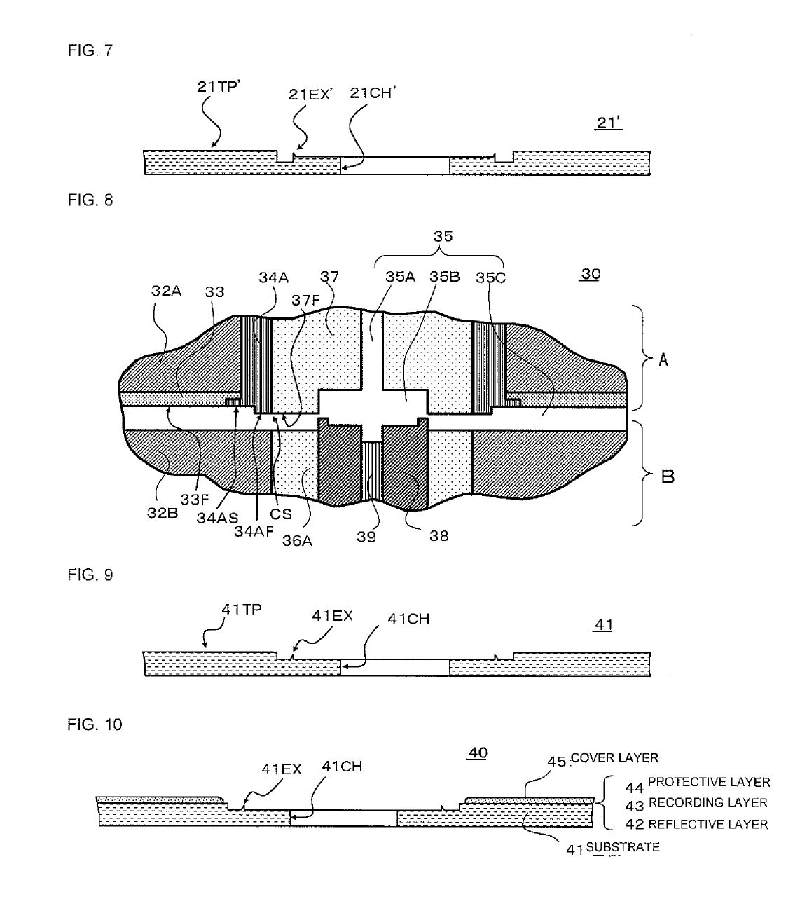

Next, a molding die apparatus according to a modification of the first embodiment will be described with reference to FIGS. 6 and 7. FIG. 6 is a partial enlarged sectional view showing an internal structure of a molding die apparatus 10′ according to the modification of the first embodiment, and FIG. 7 is a schematic sectional view showing a substrate 21′ of an optical disk in a reversed state, which is molded by using the molding die apparatus 110 according to the modification of the first embodiment.

In the molding die apparatus 10′ according to the modification of the first embodiment, as shown in FIG. 6, a cavity 15C′ is formed by opposed surfaces of a stationary-side die A′ and a movable-side die B′.

A first different point between the molding die apparatus 10′ according to the modification and the molding die apparatus 10 according to the first embodiment is that a stamper 13′ is fixed to the surface of the movable-side die B′ opposed to the stationary-side die A′ by using a cylindrical inner peripheral holding member 14A′ and an outer peripheral holding member (not shown).

A second different point between the molding die apparatus 10′ according to the modification and the molding die apparatus 10 according to the first embodiment is that, in the inner peripheral side of the inner peripheral holding member 14A′, an inner peripheral retainer 16A′ is disposed as a die member adjacent to the cylindrical inner peripheral holding member 14A′ at the inner peripheral side thereof.

More specifically, the stationary-side die A′ includes a stationary-side die plate (not shown). A stationary-side core 12A′ is fixed to the stationary-side die plate by, e.g., bolts (not shown) while the stationary-side core 12A′ is engaged at its outer peripheral side with an outer peripheral retainer (not shown). As in the molding die apparatus 10 according to the first embodiment, the stationary-side core 12A′ is provided with a plurality of cooling water channels (not shown) for holding a die temperature constant to cool and solidify the substrate. A sprue bush 17′ is disposed adjacent to the stationary-side core 12A′ at the inner peripheral side thereof.

A molten resin channel 15′ is constituted by a sprue portion 15A′, a runner portion 15B′, and the cavity 15C′.

The movable-side die B′ includes a movable-side die plate (not shown). A movable-side core 12B′ is fixed to the movable-side die plate by, e.g., bolts (not shown) such that the movable-side core 12B′ is engaged at its inner peripheral side with an inner peripheral retainer 16A′. A stamper 13′ is mounted to a surface of the movable-side core 12B′, which is positioned to face the cavity 15C′, by using an inner peripheral holding member 14A′ and an outer peripheral holding member (not shown). Though not shown, concaves and convexes corresponding to guide grooves for the substrate of the optical disk, pits for pre-formatting signals, etc. are formed in a transfer surface 13′F of the stamper 13′, which constitutes a surface defining part of the cavity 15C′. The inner peripheral retainer 16A′ is disposed as a die member adjacent to the inner peripheral holding member 14A′ at the inner peripheral side thereof. The inner peripheral retainer 16A′ slides perpendicularly to a surface of the inner peripheral holding member 14A′, which is positioned to face the stationary-side die A′.

A center hole boring punch 18′ for punching a center hole 21CH′ in the molded substrate to provide a shape of the optical disk is disposed at the inner peripheral side of the inner peripheral retainer 16A′. Further, at the center of the center hole boring punch 18′, a sprue lock pin 19′ is disposed to eject the resin, which has been cooled and solidified in the sprue portion 15A′ and the runner portion 15B′ each constituting the molten resin channel 15′, when the substrate is taken out.

The operation of molding the substrate of the optical disk by the molding die apparatus 10′ will be described below. First, by using a die fastening mechanism (not shown), the stationary-side die plate (not shown) and the movable-side die plate (not shown) are joined with each other to form the cavity 15C′ and are fastened together at high pressure. Then, a resin, e.g., an acrylic resin or a polycarbonate resin, which is heated to high temperature and kept in a molten state, is injected from an injection cylinder (not shown).

The injected molten resin passes through the sprue portion 15A′ and the runner portion 15B′, and is filled into the cavity 15C′ for molding the substrate. Because the sprue portion 15A′ and the runner portion 15B′ are formed at the center of the stationary-side core 12A′, the molten resin is substantially radially uniformly filled into the cavity 15C′.

The molten resin filled in the cavity 15C′ is cooled and solidified through heat exchange with cooling water flowing through the cooling water channels (not shown). As a result, the substrate 21′ is formed in the cavity 15C′.

During the above step, a center hole 21CH′ of the substrate 21′ is formed by the center hole boring punch 18′.

Thereafter, the molding die apparatus 10′ is separated into the stationary-side die A′ and the movable-side die B′, and the substrate 21′ in the form of a disk having the center hole 21CH′ is taken out, the substrate 21′ as shown in FIG. 7.

At that time, the resin cooled and solidified in the sprue portion 15A′ and the runner portion 15B′ is also taken out in a state adhering to the movable-side die B′. That resin is removed to the exterior of the molding die apparatus 10′ by ejecting the sprue lock pin 19′.

Further, in the molding die apparatus 10′, the transfer surface 13′F of the stamper 13′ is positioned substantially flush with a partial surface 14A′S of the inner peripheral holding member 14A′ for holding the stamper 13′ near its inner peripheral portion, the partial surface 14A′S being adjacent to the transfer surface 13F′ of the stamper 13′.

Still further, a distal end 14A′F of the inner peripheral holding member 14A′, which is positioned to face the cavity 15C′, and a distal end 16A′F of the inner peripheral retainer 16A′, which is also positioned to face the cavity 15C′, the inner peripheral retainer 16A′ being disposed as the die member adjacent to the inner peripheral holding member 14A′ at the inner peripheral side thereof, are both projected toward the more inner side of the cavity 15C′ than the partial surface 14A′S of the inner peripheral holding member 14A′, which is positioned adjacent to the transfer surface 13F′ of the stamper 13′.

As shown in FIG. 7, therefore, a surface of the substrate 21′ is recessed relative to a transfer portion 21TP′ of the substrate 21′, to which the transfer surface 13′F of the stamper 13′ has been transferred, in an area subjected to transfer of both the distal end 14A′F of the inner peripheral holding member 14A′, which is positioned to face the cavity 15C′, and the distal end 16A′F of the inner peripheral retainer 16A′, which is also positioned to face the cavity 15C′, the inner peripheral retainer 16A′ being disposed as the die member adjacent to the inner peripheral holding member 14A′ at the inner peripheral side thereof. Hence, a molding burr 21EX′ formed on the substrate 21′ along a sliding surface between the inner peripheral holding member 14A′ and the inner peripheral retainer 16A′ disposed as the die member adjacent to the inner peripheral holding member 14A′ at the inner peripheral side thereof is located in the recessed portion in the surface of the substrate 21′. As a result, the molding burr 21EX′ is suppressed from projecting upward from the vicinity of an inner peripheral edge of the substrate surface which is substantially flush with the transfer portion 21TP′ in one principal surface of the substrate 21′.

The molded substrate 21′ has, on its one principal surface to which the transfer surface 13′F of the stamper 13′ has been transferred, the transfer portion 21TP′ including the guide grooves, the pits for the pre-formatting signals, etc. (not shown).

Moreover, in the molding die apparatus 10′ of this modification, the distal end 14A′F of the inner peripheral holding member 14A′, which is positioned to face the cavity 15C′, is projected toward the more inner side of the cavity 15C′ than the distal end 16A′F of the inner peripheral retainer 16A′, which is also positioned to face the cavity 15C′, the inner peripheral retainer 16A′ being disposed as the die member adjacent to the inner peripheral holding member 14A′ at the inner peripheral side thereof. This arrangement provides such a merit that, as in the molding die apparatus 10 of the first embodiment, resistance against the molten resin flowing in the cavity 15C′ is relatively small.

An optical disk using the substrate 21′ molded by the molding die apparatus 10′ of this modification is similar to the above-described optical disk according to the first embodiment, and therefore a description thereof is omitted here.

A molding die apparatus according to a second embodiment of the present invention will be described below with reference to FIGS. 8 and 9. FIG. 8 is a partial enlarged sectional view showing an internal structure of a molding die apparatus 30 according to the second embodiment, and FIG. 9 is a partial enlarged sectional view showing a substrate 41 of an optical disk, which is molded by using the molding die apparatus 30 according to the second embodiment.

In the molding die apparatus 30 according to the second embodiment, as shown in FIG. 8, a cavity 35C is formed by opposed surfaces of a stationary-side die A and a movable-side die B.

The stationary-side die A includes a stationary-side die plate (not shown). A stationary-side core 32A is fixed to the stationary-side die plate by, e.g., bolts (not shown). The stationary-side core 32A is provided with a plurality of cooling water channels (not shown) for holding a die temperature constant to cool and solidify the substrate. A stamper 33 is mounted to a surface of the stationary-side core 32A, which is positioned to face the cavity 35C, by using an inner peripheral holding member 34A, which has a hollow cylindrical shape and includes a flange formed on an outer periphery of its head portion, and an outer peripheral holding member (not shown). Concaves and convexes corresponding to guide grooves for the substrate of the optical disk, pits for pre-formatting signals, etc. (not shown) are formed in a transfer surface 33F of the stamper 33, which constitutes a surface defining part of the cavity 35C. In addition, a thin wall portion is formed at the inner peripheral side of the stamper 33 to be engaged with the flange that is formed in the head portion of the inner peripheral holding member 34A.

A sprue bush 37 is disposed as a die member adjacent to the inner peripheral holding member 34A at the inner peripheral side thereof. The sprue bush 37 slides perpendicularly to a surface of the inner peripheral holding member 34A, which is positioned to face the movable-side die B.

A molten resin channel 35 is constituted by a sprue portion 35A, a runner portion 35B, and the cavity 35C for molding the substrate.

The movable-side die B includes a movable-side die plate (not shown). A movable-side core 32B is fixed to the movable-side die plate by, e.g., bolts (not shown) such that the movable-side core 32B is engaged at its inner peripheral side with an inner peripheral retainer 36A and at its outer peripheral side with an outer peripheral retainer (not shown). A center hole boring punch 38 for punching a center hole 41CH in the molded substrate to provide a shape of the optical disk is disposed at the inner peripheral side of the inner peripheral retainer 36A. Further, at the center of the center hole boring punch 38, a sprue lock pin 39 is disposed to eject the resin, which has been cooled and solidified in the sprue portion 35A and the runner portion 35B each constituting the molten resin channel 35, when the substrate is taken out.

The operation of the molding die apparatus 30 of this second embodiment for molding the substrate of the optical disk is similar to that in the above-described first embodiment, and therefore a description of the operation is omitted here.

The molding die apparatus 30 of this second embodiment differs from the molding die apparatus 10 of the first embodiment in the following point. In the molding die apparatus 30 of this second embodiment, the distal end 34AF of the inner peripheral holding member 34A, which is positioned to face the cavity 35C, is projected toward the inner side of the cavity 35C by the same dimension as the distal end 37F of the sprue bush 37, which is also positioned to face the cavity 35C, the sprue bush 37 being disposed as the die member adjacent to the inner peripheral holding member 34A at the inner peripheral side thereof. This arrangement provides such a merit that a position up to which a distal end of the molding burr formed in the recessed portion projects can be held at a lower level.

Since the other construction and working advantages of the molding die apparatus according to this second embodiment are similar to those of the first embodiment, a description thereof is omitted here.

The molded substrate 41 has, on its one principal surface to which the transfer surface 33F of the stamper 33 has been transferred, a transfer portion 41TP including the guide grooves, the pits for the pre-formatting signals, etc. (not shown).

The optical disk according to the second embodiment of the present invention will be described below with reference to FIG. 10. FIG. 10 is a partial enlarged sectional view showing an internal structure of an optical disk 40 according to the second embodiment of the present invention.

In the optical disk 40 according to the second embodiment, wherein the following layers are denoted just by reference numerals in FIG. 10 instead of detailed illustration, a reflective layer 42 made of a metal or an alloy, a recording layer 43 containing a dye, etc., and a protective layer 44 made of, e.g., a transparent inorganic material are formed in this order on the transfer portion 41TP of the substrate 41 which has been molded by using the molding die apparatus 30. Further, a cover layer 45 made of a transparent resin film having a thickness of about 0.1 mm is formed to cover the protective layer 44. The optical disk 40 is thus obtained in the above-described structure.

Since the other construction and working advantages of the optical disk according to this second embodiment are similar to those of the first embodiment, a description thereof is omitted here.

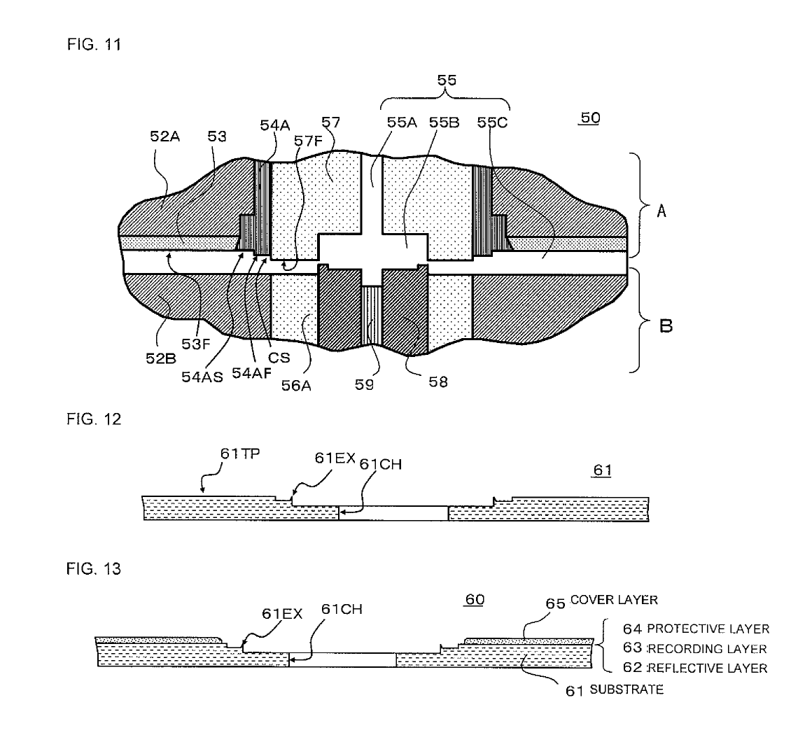

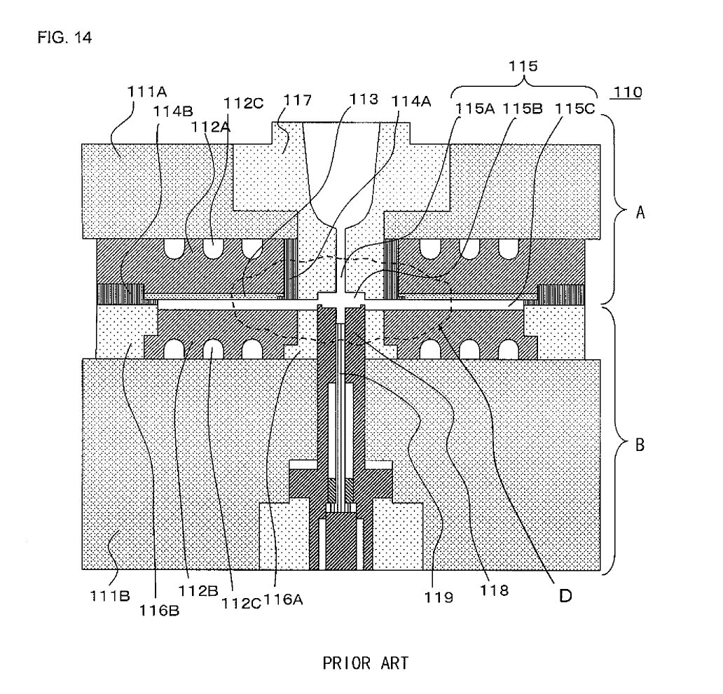

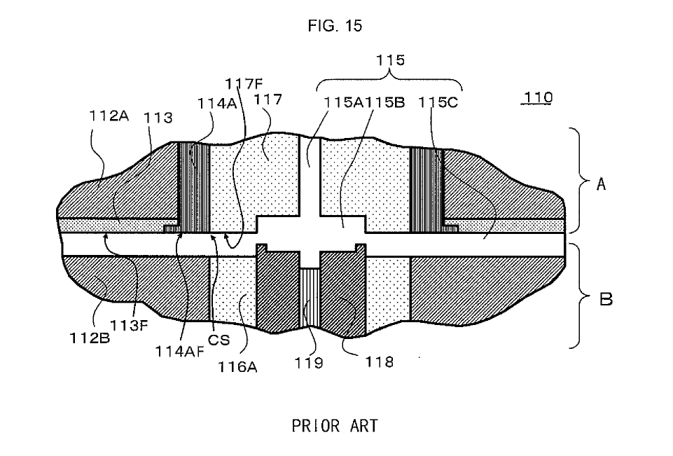

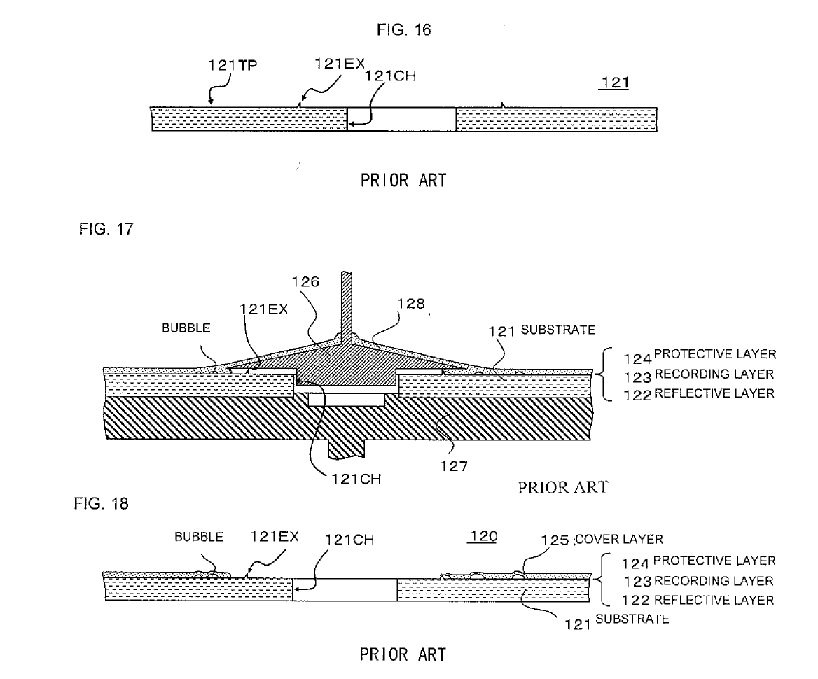

A molding die apparatus according to a third embodiment of the present invention will be described below with reference to FIGS. 11 and 12. FIG. 11 is a partial enlarged sectional view showing an internal structure of a molding die apparatus 50 according to the third embodiment, and FIG. 12 is a partial enlarged sectional view showing a substrate 61 of an optical disk, which is molded by using the molding die apparatus 50 according to the third embodiment.

In the molding die apparatus 50 according to the third embodiment, as shown in FIG. 11, a cavity 55C is formed by opposed surfaces of a stationary-side die A and a movable-side die B.

The stationary-side die A includes a stationary-side die plate (not shown). A stationary-side core 52A is fixed to the stationary-side die plate by, e.g., bolts (not shown). The stationary-side core 52A is provided with a plurality of cooling water channels (not shown) for holding a die temperature constant to cool and solidify the substrate. A stamper 53 is mounted to a surface of the stationary-side core 52A, which is positioned to face the cavity 55C, by using an inner peripheral holding member 54A, which has a hollow cylindrical shape and includes a tapered extension formed on an outer periphery of its head portion, and an outer peripheral holding member (not shown). Concaves and convexes corresponding to guide grooves for the substrate of the optical disk, pits for pre-formatting signals, etc. (not shown) are formed in a transfer surface 53F of the stamper 53, which constitutes a surface defining part of the cavity 55C. In addition, an inner peripheral surface of the stamper 53 is formed in a tapered sectional shape to be engaged with the tapered extension that is formed in the head portion of the inner peripheral holding member 54A.

A sprue bush 57 is disposed as a die member adjacent to the inner peripheral holding member 54A at the inner peripheral side thereof. The sprue bush 57 slides perpendicularly to a surface of the inner peripheral holding member 54A, which is positioned to face the movable-side die B.

A molten resin channel 55 is constituted by a sprue portion 55A, a runner portion 55B, and the cavity 55C for molding the substrate.

The movable-side die B includes a movable-side die plate (not shown). A movable-side core 52B is fixed to the movable-side die plate by, e.g., bolts (not shown) such that the movable-side core 52B is engaged at its inner peripheral side with an inner peripheral retainer 56A and at its outer peripheral side with an outer peripheral retainer (not shown).

A center hole boring punch 58 for punching a center hole 61CH in the molded substrate to provide a shape of the optical disk is disposed at the inner peripheral side of the inner peripheral retainer 56A. Further, at the center of the center hole boring punch 58, a sprue lock pin 59 is disposed to eject the resin, which has been cooled and solidified in the sprue portion 55A and the runner portion 55B each constituting the molten resin channel 55, when the substrate is taken out.

The operation of the molding die apparatus 50 of this third embodiment for molding the substrate of the optical disk is similar to that in the above-described first embodiment, and therefore a description of the operation is omitted here.

The molding die apparatus 50 of this third embodiment differs from the molding die apparatus 10 of the first embodiment in the following point. In the molding die apparatus 50 of this third embodiment, the distal end 57F of the sprue bush 57, which is positioned to face the cavity 55C, the sprue bush 57 being disposed as the die member adjacent to the inner peripheral holding member 54A at the inner peripheral side thereof, is projected toward the more inner side of the cavity 55C than the distal end 54AF of the inner peripheral holding member 54A, which is also positioned to face the cavity 55C.

Since the other construction and working advantages of the molding die apparatus according to this third embodiment are similar to those of the first embodiment, a description thereof is omitted here.

The molded substrate 61 has, on its one principal surface to which the transfer surface 53F of the stamper 53 has been transferred, a transfer portion 61TP including the guide grooves, the pits for the pre-formatting signals, etc. (not shown).

The optical disk according to the third embodiment of the present invention will be described below with reference to FIG. 13. FIG. 13 is a partial enlarged sectional view showing an internal structure of an optical disk 60 according to the third embodiment of the present invention.

In the optical disk 60 according to the third embodiment, wherein the following layers are denoted just by reference numerals in FIG. 13 instead of detailed illustration, a reflective layer 62 made of a metal or an alloy, a recording layer 63 containing a dye, etc., and a protective layer 64 made of, e.g., a transparent inorganic material are formed in this order on the transfer portion 61TP of the substrate 61 which has been molded by using the molding die apparatus 50. Further, a cover layer 65 made of a transparent resin film having a thickness of about 0.1 mm is formed to cover the protective layer 64. The optical disk 60 is thus obtained in the above-described structure.

Since the other construction and working advantages of the optical disk according to this third embodiment are similar to those of the first embodiment, a description thereof is omitted here.

The structure and the operation of the present invention are not limited to the above descriptions. Various modifications may be made without departing from the spirit and scope of the present invention, and other embodiments and modifications apparent to those of ordinary skill in the art are also within the scope of the present invention. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. For example, various aspects of one or several embodiments can be used with another or several embodiments. The scope of the invention is indicated by the appended claims rather than by the foregoing description. All changes which come within the meaning and range of equivalency of the claims are to be embraced within their scope.

1. A molding die apparatus for molding a disk-shaped substrate having a center hole, comprising:
a stationary-side die and a movable-side die, the stationary-side die and the movable-side die forming a cavity by opposed surfaces thereof, at least one of the stationary-side die and the movable-side die comprising a stamper which has a transfer surface formed in one principal surface thereof and which is mounted to one of the opposed surfaces to constitute a surface defining part of the cavity,
wherein the transfer surface of the stamper is positioned substantially flush with and adjacent to a first distal surface portion of an inner peripheral holding member, the inner peripheral holding member configured to hold the stamper near an inner periphery thereof and
wherein a second distal surface portion of the inner peripheral holding member, which is positioned to face the cavity, and a distal surface portion of a die member, which is positioned to face the cavity, the die member being disposed adjacent to the inner peripheral holding member at the inner peripheral side thereof, are both projected more into the cavity than the first distal surface of the inner peripheral holding member.

2. The molding die apparatus of claim 1, wherein the second distal surface portion projects into the cavity by approximately 0.02 mm to 1.0 mm more than the first distal surface portion.

3. The molding die apparatus of claim 1, wherein a width of the second distal surface portion is approximately 0.02 mm to 1.0 mm.

4. The molding die apparatus of claim 1, wherein the second distal surface portion is substantially flush with the distal surface portion of the die member.

5. The molding die apparatus of claim 1, wherein the second distal surface portion projects more into the cavity than the distal surface portion of the die member.

6. The molding die apparatus of claim 1, wherein the distal surface portion of the die member projects more into the cavity than the second distal surface portion.

7. The molding die apparatus of claim 1, wherein the inner peripheral member comprises a flange on an outer periphery thereof, the flange being configured to overlap a portion of the stamper.

8. The molding die apparatus of claim 1, wherein the inner peripheral member comprises a tapered extension configured to overlap a tapered section of the stamper.

9. The molding die apparatus of claim 1, wherein the transfer surface comprises a series of concaves and convexes, or a series of pits.

10. An optical disk comprising a disk-shaped substrate having a center hole, the substrate comprising a transfer portion, a first recessed portion adjacent to an inner periphery of the transfer portion, and a second recessed portion adjacent to an inner periphery of the first recessed portion, wherein the transfer portion comprises a first surface with guide grooves or pits formed therein, wherein the first recessed portion and the second recessed portion are recessed relative to the first surface of the transfer portion, and wherein the first recessed portion and the second recessed portion are separated by a molding burr formed at the inner periphery of the first recessed portion, said molding burr having a height which is less than the depth of the recessed portions.

11. The optical disk of claim 10, wherein the first recessed portion is recessed relative to the first surface by approximately 0.02 mm to 1.0 mm.

12. The optical disk of claim 10, wherein a width of the first recessed portion is approximately 0.02 mm to 1.0 mm.

13. The optical disk of claim 10, wherein the second recessed portion is recessed relative to the first recessed portion.

14. The optical disk of claim 10, wherein the first recessed portion is recessed relative to the second recessed portion.

15. A method of improving contact between an optical disk and a center cap attached to said optical disk during a spin coating process, the method comprising recessing a central region of said optical disk such that a molding burr in the recessed region has insufficient height to contact said center cap when said center cap is engaged with said optical disk.

16. The method of claim 15, further comprising setting said center cap to cover a center hole of the optical disk and an area of a surface of the optical disk extending from a vicinity of an inner peripheral edge of the optical disk positioned substantially flush with and adjacent to a transfer portion of the optical disk.
